(19) United States
(12) Patent Application Publication
(10) Pub. No.: US 2022/0039432 A1
(43) Pub. Date: Feb. 10, 2022

(54) BEVERAGE OR POWDERED BEVERAGE CONTAINING BREAKDOWN PRODUCT OF THALLUS OF PLANT OF SUBFAMILY LEMNOIDEAE

(71) Applicant: AJINOMOTO CO., INC., Tokyo (JP)

(72) Inventor: Souichirou Hata, Kanagawa (JP)

(73) Assignee: AJINOMOTO CO., INC., Tokyo (JP)

(21) Appl. No.: 17/505,196

(22) Filed: Oct. 19, 2021

Related U.S. Application Data
(63) Continuation of application No. PCT/JP2020/014447, filed on Mar. 30, 2020.

(30) Foreign Application Priority Data
Apr. 22, 2019 (JP) 2019-080900

(51) Int. Cl. A23L 2/52; A23L 29/00; A23L 33/105; A23L 2/395

(52) U.S. Cl. CPC A23L 2/52; A23L 2/395; A23L 33/105; A23L 29/035

(57) ABSTRACT

Provided herein are drinks or powdered drinks containing a destroyed frond of a Lemnoideae plant having improved feeling of sliminess and/or powderiness in the mouth, and a method for improving sliminess and/or powderiness in the mouth of drinks or powdered drinks containing destroyed fronds of a Lemnoideae plant. Also provided herein are drinks or powdered drinks containing destroyed fronds of a Lemnoideae plant, and organic acid salt or organic acid; and a method for improving the feeling of sliminess and/or powderiness in the mouth, including adding an organic acid salt or organic acid to drinks or powdered drinks containing destroyed fronds of a Lemnoideae plant.

This application is a Continuation of, and claims priority under 35 U.S.C. § 120 to, International Application No. PCT/JP2020/014447, filed Mar. 30, 2020, and claims priority therethrough under 35 U.S.C. § 119 to Japanese Patent Application No. 2019-080900, filed Apr. 22, 2019, the entireties of which are incorporated by reference herein.

### BACKGROUND

### Technical Field

Described herein are drinks or powdered drinks containing destroyed fronds of a Lemnoideae plant wherein the sliminess feeling and/or powderiness feeling in the mouth is improved, and a method for improving the sliminess and/or powderiness of drinks or powdered drinks containing destroyed fronds of a Lemnoideae plant in the mouth.

### Background Art

Wolffia globosa, which is one type of Lemnoideae plant, is high in protein, has good amino acid balance, is absorbed well, and is allergen-free. Therefore, its use as a food or drink product that can be easily taken to supplement nutrition in good balance has been reported.

Patent document 1 discloses the use of a plant of the Wolffia genus as a coloring agent, and patent document 2 discloses a dough containing a plant of Wolffia genus. However, ease of drinking when destroyed fronds of the Lemnoideae plant, e.g., Wolffia globosa, is ingested as a drink has not been studied.

### PATENT DOCUMENTS

Patent document 1: Japanese Translation of PCT Application Publication No. 2015-523096
Patent document 2: Japanese Translation of PCT Application Publication No. 2017-504338

### SUMMARY

The fronds of Lemnoideae plants, e.g., Wolffia globosa, that are destroyed when formulated as a food have a peculiar sliminess and/or an insoluble substance, which in turn causes a problem that drinks obtained by dissolving or dispersing the fronds in water are difficult to drink due to the feeling of sliminess and/or the powderiness in the mouth.

A dry powder obtained by drying destroyed fronds of Lemnoideae plants, e.g., Wolffia globosa, is preferable in terms of ease of handling, storability, and the like. However, drinks obtained by dissolving or dispersing the dry powder in water provide a powdery feeling, particularly in the mouth.

As described, when a destroyed frond of a Lemnoideae plant is to be used in a drink, improving the ease of drinking is necessary and poses a problem, that is, improving the feeling of sliminess in the mouth and improving the feeling of powderiness in the mouth is desirable.

Described herein are drinks or powdered drinks containing a destroyed frond of a Lemnoideae plant wherein the sliminess and/or powderiness feeling in the mouth is improved, and a method for improving the sliminess and/or powderiness feeling in the mouth when drinking drinks or powdered drinks containing a destroyed frond of a Lemnoideae plant.

Described herein is the ability to suppress the sliminess and powderiness feeling in the mouth when the destroyed frond of a Lemnoideae plant is used in a drink and that the ease of drinking can be improved by adding an organic acid salt or organic acid to the destroyed frond of a Lemnoideae plant.

It is an aspect of the present invention to provide a drink or powdered drink comprising a destroyed frond of a Lemnoideae plant, and an organic acid salt or organic acid.

It is a further aspect of the present invention to provide the drink or powdered drink as described above, wherein the organic acid salt is citrate or gluconate.

It is a further aspect of the present invention to provide the drink or powdered drink as described above, wherein the organic acid salt is trisodium citrate.

It is a further aspect of the present invention to provide a method for improving a sliminess and/or powderiness feeling in the mouth, comprising adding an organic acid salt or organic acid to a drink or powdered drink comprising a destroyed frond of a Lemnoideae plant.

It is a further aspect of the present invention to provide the method of the as described above, wherein the organic acid salt is citrate or gluconate.

It is a further aspect of the present invention to provide the method as described above, wherein the organic acid salt is trisodium citrate.

The sliminess and/or powderiness feeling in the mouth of drinks or powdered drinks containing destroyed fronds of a Lemnoideae plant are/is improved, and the ease of drinking thereof is improved by adding an organic acid salt or organic acid.

### DETAILED DESCRIPTION

The drinks and powdered drinks as described herein contain destroyed fronds of a Lemnoideae plant, and an organic acid salt or organic acid.

Examples of the Lemnoideae plant include Wolffia globosa, Wolffia angusta, Wolffia arrhiza, Wolffia australiana, Wolffia borealis, Wolffia brasiliensis, Wolffia columbiana, Wolffia cylindracea, Wolffia elongata, Wolffia microscopica.

The “destroyed frond of a Lemnoideae plant” is obtained by applying force such as compression, impact, shear, friction, and the like. The degree of destruction is not limited, and the frond may be only partially destroyed.

The destroyed frond of a Lemnoideae plant can be produced by, for example, destroying the frond of a Lemnoideae plant with a squeezing machine, a shearing machine, or the like.

The destroyed frond of a Lemnoideae plant may be a dried product, and a commercially available dry powder of the destroyed frond of a Lemnoideae plant (e.g., “Mankai” D110 (trade name), Hinoman Ltd.) may be used.

A dry powder of the destroyed frond of a Lemnoideae plant powder is obtained, for example, by destroying, such as by, e.g., compression, fronds of a Lemnoideae plant, followed by drying. The drying can be performed by a drying method generally used in the field of food or pharmaceutical preparation. For example, the moisture removal or drying method includes sun drying, heating devices, freeze drying, spray drying, fluidized bed drying, vacuum drying, capillary extraction, and combinations thereof. Any other generally used and/or industrially acceptable techniques not limited to these can also be used.

Examples of the organic acid salt include alkali metal salts, e.g., sodium salt, potassium salt; and alkaline earth metal salts, e.g., calcium salt, with organic acids such as citric acid, gluconic acid, lactic acid, malic acid, and the like.

The organic acid salt can be, specifically, for example, citrate, e.g., sodium citrate, e.g., trisodium citrate, potassium citrate, calcium citrate; gluconate, e.g., calcium gluconate, sodium gluconate, potassium gluconate; lactate, e.g., fermented calcium lactate, calcium lactate, sodium lactate; or malate.

In the drinks and powdered drinks, the amount of the organic acid salt for the purpose of improving the feeling of powderiness is, for example, not less than 0.0025 parts by weight, or not less than 0.015 parts by weight, per 1 part by weight in dry weight of the destroyed frond of a Lemnoideae plant.

In the drinks and powdered drinks, the amount of the organic acid salt for the purpose of improving the feeling of sliminess is, for example, not less than 0.0025 parts by weight, not less than 0.005 parts by weight, or not less than 0.015 parts by weight, per 1 part by weight in dry weight of the destroyed frond of a Lemnoideae plant.

The amount of the organic acid salt for the purpose of improving powderiness and sliminess is, for example, not less than 0.0025 parts by weight, not less than 0.005 parts by weight, or not less than 0.015 parts by weight, per 1 part by weight in dry weight of the destroyed frond of a Lemnoideae plant.

The amount of the organic acid salt is, for example, not more than 1 part by weight, per 1 part by weight in dry weight of the destroyed frond of a Lemnoideae plant.

Examples of the organic acid include citric acid, malic acid, ascorbic acid, gluconic acid, succinic acid, tartaric acid, fumaric acid, lactic acid, acetic acid, glutamic acid, aspartic acid, and adipic acid.

In the drinks and powdered drinks, the amount of the organic acid for the purpose of improving the feeling of powderiness is, for example, not less than 0.01 parts by weight, or not less than 0.015 parts by weight, per 1 part by weight in dry weight of the destroyed frond of a Lemnoideae plant.

In the drinks and powdered drinks, the amount of the organic acid for the purpose of improving the feeling of sliminess is, for example, not less than 0.0025 parts by weight, not less than 0.005 parts by weight, or not less than 0.01 part by weight, per 1 part by weight in dry weight of the destroyed frond of a Lemnoideae plant.

The amount of the organic acid salt for the purpose of improving the feelings of powderiness and sliminess is, for example, not less than 0.01 part by weight, or not less than 0.015 parts by weight, per 1 part by weight in dry weight of the destroyed frond of a Lemnoideae plant.

The amount of the organic acid is, for example, not more than 1 part by weight per 1 part by weight in dry weight of the destroyed frond of a Lemnoideae plant.

In the drinks as described herein, destroyed fronds of a Lemnoideae plant, and an organic acid salt or organic acid are dissolved or dispersed in typical drinks, e.g., water, carbonated water, milk, soy milk, vegetable juice, and fruit juice.

In the drinks as described herein, the weight ratio of the typical drinks and the “total weight of destroyed frond of a Lemnoideae plant in dry weight and organic acid salt or organic acid,” that is, the weight of general drinks:total weight of destroyed frond of a Lemnoideae plant in dry weight and organic acid salt or organic acid, is, for example, 1:not less than 0.0025, 1:not less than 0.01, or 1:not less than 0.015.

In the drinks, the weight ratio of the typical drinks and the “total weight of destroyed frond of a Lemnoideae plant in dry weight and organic acid salt or organic acid,” that is, the weight of general drinks:total weight of destroyed frond of a Lemnoideae plant in dry weight and organic acid salt or organic acid is, for example, 1:0.0025-1, 1:0.01-1, or 1:0.015-1.

The drinks as described herein may further contain a component other than the above-mentioned components as long as the desired effect is not impaired, for example, an additive typically used in typical drinks or powdered drinks, e.g., sweetener, e.g., aspartame, acesulfame K, stevia, carbohydrates; acidulant, e.g., citric acid, malic acid, ascorbic acid, gluconic acid, succinic acid, tartaric acid, fumaric acid, lactic acid, acetic acid, glutamic acid, aspartic acid and adipic acid.

In the drinks as described herein, the amount of the additive which may be freely added as described above may be appropriately determined based on amounts typically used.

The drinks as described herein can be produced by dissolving or dispersing the above-mentioned components in typical drinks, e.g., water, carbonated water, milk, soy milk, vegetable juice, and fruit juice.

The addition method and the order of addition of the destroyed fronds of a Lemnoideae plant and the organic acid salt or organic acid to the drinks are not particularly limited, and the destroyed fronds of a Lemnoideae plant and the organic acid salt or organic acid may be separately added simultaneously or sequentially, or the destroyed fronds of a Lemnoideae plant and the organic acid salt or organic acid may be mixed and then added.

The mixing can be performed by a mixing method generally used in the field of food or pharmaceutical preparation.

The powdered drink is a drink that is sold, stored, or the like in the state of a powder, and is dissolved or dispersed in a typical drink, e.g., water, carbonated water, milk, soy milk, vegetable juice, fruit juice, at the time of use.

Examples of the powdered drink include powdered drinks containing the destroyed frond of a Lemnoideae plant and the organic acid salt at the above-mentioned weight ratio, powdered drinks containing the destroyed frond of a Lemnoideae plant and the organic acid at the above-mentioned weight ratio.

The powdered drinks may further contain a component other than the above-mentioned components as long as the desired effect is not impaired, for example, an additive commonly used in drinks or powdered drinks, e.g., sweetener, e.g., aspartame, acesulfame K, stevia, carbohydrates; acidulant, e.g., citric acid, malic acid, ascorbic acid, gluconic acid, succinic acid, tartaric acid, fumaric acid, lactic acid, acetic acid, glutamic acid, aspartic acid and adipic acid.

In the powdered drinks as described herein, the content of the additive which may be freely added as described above is, for example, 0-99 wt %, 0-50 wt %, or 0-30 wt %.

The powdered drinks can be produced, for example, by mixing such as powder mixing, a dry powder of destroyed fronds of a Lemnoideae plant and an organic acid salt or organic acid. Furthermore, the above-mentioned additives may be added and mixed by a known method. The mixing can be performed by a mixing method generally used in the field of food or pharmaceutical preparation.

When the powdered drink as described herein is dissolved or dispersed in typical drinks when in use, the weight ratio of the drink and the powdered drink, that is, typical drink:powdered drink is, for example, 1:0.01-0.6, preferably 1:0.01-0.3, or 1:0.01-0.1.

The drink or powdered drink as described herein is a concept that broadly encompasses foods that can be taken orally, excluding pharmaceuticals, and includes health supplements, foods with health claims, e.g., foods for specified health uses, foods with functional claims, foods with nutrient function claims, supplements, and the like.

The drink or powdered drink can be safely ingested by humans and other mammals, e.g., mouse, rat, hamster, rabbit, cat, dog, bovine, sheep, and monkey; and also birds, e.g., chicken, turkey.

Also described herein is a method for improving the feeling of sliminess and/or powderiness in the mouth, by adding an organic acid salt or organic acid to a drink or powdered drink containing destroyed fronds of a Lemnoideae plant, hereinafter to be referred to as the method or the method as described herein.

In the method as described herein, the examples and amount (ratio) of the “destroyed frond of a Lemnoideae plant”, “organic acid salt” and “organic acid”, and the definition and production method of the “drinks” and “powdered drinks” are the same as the examples and amount (ratio) of the “destroyed frond of a Lemnoideae plant”, “organic acid salt” and “organic acid”, and the definition and production method of the “drinks” and “powdered drinks” explained for the above-mentioned drinks or powdered drinks. In the method, the drinks and powdered drinks may contain the above-mentioned additive which may be freely added.

According to the method, the feeling of sliminess and/or powderiness in the mouth of drinks or powdered drinks containing destroyed fronds of a Lemnoideae plant can be improved by adding an organic acid salt or organic acid.

### EXAMPLE

The present invention is explained in more detail in the following by referring to Examples, Comparative Examples, and Experimental Example, which are not to be construed as limitative.

### Examples 1-16, Comparative Examples 1-13, Reference Example 1

2 g of dry powder of a destroyed frond of Wolffia globosa (“Mankai” D110™, Hinoman Ltd.) was mixed with various compounds shown in the following Tables 2-8 in the amounts shown in the Tables to prepare mixed powders, powdered drinks, of Comparative Examples 2-13 containing sweetener, Examples 1-8 containing organic acid, Examples 9-16 containing organic acid salt, and Reference Example 1 containing inorganic salt. A dry powder, that is, a powdered drink, of only destroyed frond of Wolffia globosa was used as Comparative Example 1 (control).

0.5 g each of the mixed powders, that is, the powdered drinks of Examples 1-16, Comparative Examples 1-13, and Reference Example 1 were collected and dissolved in 7.5 g of water to prepare the drinks of Examples 1-16, Comparative Examples 1-13 and Reference Example 1.

Experimental Example 1 Determination of the effect of blending of sweetener, organic acid, organic acid salt, inorganic salt with drinks containing destroyed fronds of Wolffia globosa on sliminess and powderiness in mouth

Changes in the feeling of sliminess and powderiness in the mouth of the drinks of Examples 1-16, Comparative Examples 2-13 and Reference Example 1 relative to Comparative Example 1 (control) were studied. The evaluation was performed by sensory evaluation of one professional panelist. The evaluation criteria are as shown in the following Table 1. The results are shown in the following Tables 2-8.

As shown in Tables 2-8, the organic acid and organic acid salt have a high reducing effect on the feeling of sliminess and powderiness in the mouth of drinks containing destroyed fronds of Wolffia globosa.

TABLE 1

| sensory score | 1 | 2 | 3 | 4 | 5 |
|---|---|---|---|---|---|
| powderiness in | strongly felt | felt | somewhat | slightly felt | not felt |
| mouth | | | felt | | |
| sliminess in mouth | strongly felt | felt | somewhat | slightly felt | not felt |
| | | | felt | | |

TABLE 2

| | Comparative | | Comparative | | Comparative | | Comparative | | Comparative | |
|---|---|---|---|---|---|---|---|---|---|---|
| | Example 1 | | Example 2 | | Example 3 | | Example 4 | | Example 5 | |
| | | mixing | | mixing | | mixing | | mixing | | mixing |
| | amount | ratio | amount | ratio | amount | ratio | amount | ratio | amount | ratio |
| | (g) | (%) | (g) | (%) | (g) | (%) | (g) | (%) | (g) | (%) |
| dry powder | 2 | 100.00 | 2 | 99.98 | 2 | 99.95 | 2 | 99.93 | 2 | 99.90 |
| of destroyed | | | | | | | | | | |
| frond of | | | | | | | | | | |
| Wolffia globosa | | | | | | | | | | |
| aspartame | — | — | 0.0005 | 0.02 | 0.001 | 0.05 | 0.0015 | 0.07 | 0.002 | 0.10 |
| acesulfame K | — | — | — | — | — | — | — | — | — | — |
| stevia | — | — | — | — | — | — | — | — | — | — |
| powder sugar | — | — | — | — | — | — | — | — | — | — |

| | | | | | |
|---|---|---|---|---|---|
| powderiness | 1 | 1 | 1 | 1 | 1 |
| in mouth | | | | | |
| sliminess | 1 | 1 | 1 | 1 | 1 |
| in mouth | | | | | |

TABLE 3

| | Comparative | | Compatative | | Comparative | | Comparative | |
|---|---|---|---|---|---|---|---|---|
| | Example 6 | | Example 7 | | Example 8 | | Example 9 | |
| | | mixing | | mixing | | mixing | | mixing |
| | amount | ratio | amount | ratio | amount | ratio | amount | ratio |
| | (g) | (%) | (g) | (%) | (g) | (%) | (g) | (%) |
| dry powder of | 2 | 99.88 | 2 | 99.85 | 2 | 99.93 | 2 | 99.93 |
| destroyed frond | | | | | | | | |
| of Wolffia | | | | | | | | |
| globosa | | | | | | | | |
| aspartame | 0.0025 | 0.12 | 0.003 | 0.15 | — | — | — | — |
| acesulfame K | — | — | — | — | 0.0015 | 0.07 | — | — |
| stevia | — | — | — | — | — | — | 0.0015 | 0.07 |
| powder sugar | — | — | — | — | — | — | — | — |

| | | | | |
|---|---|---|---|---|
| powderiness | 1 | 1 | 1 | 1 |
| in mouth | | | | |
| sliminess | 1 | 1 | 1 | 1 |
| in mouth | | | | |

TABLE 4

| | Comparative | | Comparative | | Comparative | | Comparative | |
|---|---|---|---|---|---|---|---|---|
| | Example 10 | | Example 11 | | Example 12 | | Example 13 | |
| | | mixing | | mixing | | mixing | | mixing |
| | amount | ratio | amount | ratio | amount | ratio | amount | ratio |
| | (g) | (%) | (g) | (%) | (g) | (%) | (g) | (%) |
| dry powder of destroyed | 2 | 99.93 | 2 | 93.02 | 2 | 86.96 | 2 | 76.92 |
| frond of Wolffia globosa | | | | | | | | |
| aspartame | — | — | — | — | — | — | — | — |
| acesulfame K | — | — | — | — | — | — | — | — |
| stevia | — | — | — | — | — | — | — | — |
| powder sugar | 0.0015 | 0.07 | 0.15 | 6.98 | 0.3 | 13.04 | 0.6 | 23.08 |

| | | | | |
|---|---|---|---|---|
| powderiness in mouth | 1 | 1 | 1 | 1 |
| sliminess in mouth | 1 | 1 | 1 | 1 |

TABLE 5

| | Comparative | | | | | | | | | |
|---|---|---|---|---|---|---|---|---|---|---|
| | Example 1 | | Example 1 | | Example 2 | | Example 3 | | Example 4 | |
| | | mixing | | mixing | | mixing | | mixing | | mixing |
| | amount | ratio | amount | ratio | amount | ratio | amount | ratio | amount | ratio |
| | (g) | (%) | (g) | (%) | (g) | (%) | (g) | (%) | (g) | (%) |
| dry powder of destroyed | 2 | 100.00 | 2 | 99.75 | 2 | 99.50 | 2 | 99.01 | 2 | 98.52 |
| frond of Wolffia globosa | | | | | | | | | | |
| citric acid | — | — | 0.005 | 0.25 | 0.01 | 0.50 | 0.02 | 0.99 | 0.03 | 1.48 |
| malic acid | — | — | — | — | — | — | — | — | — | — |
| ascorbic acid | — | — | — | — | — | — | — | — | — | — |

| | | | | | |
|---|---|---|---|---|---|
| powderiness in mouth | 1 | 1 | 2 | 3 | 5 |
| sliminess in mouth | 1 | 3 | 4 | 5 | 5 |

TABLE 6

| | Example 5 | | Example 6 | | Example 7 | | Example 8 | |
|---|---|---|---|---|---|---|---|---|
| | | mixing | | mixing | | mixing | | mixing |
| | amount | ratio | amount | ratio | amount | ratio | amount | ratio |
| | (g) | (%) | (g) | (%) | (g) | (%) | (g) | (%) |
| dry powder of destroyed | 2 | 98.04 | 2 | 97.09 | 2 | 99.01 | 2 | 99.01 |
| frond of Wolffia globosa | | | | | | | | |
| citric acid | 0.04 | 1.96 | 0.06 | 2.91 | — | — | — | — |
| malic acid | — | — | — | — | 0.02 | 0.99 | — | — |
| ascorbic acid | — | — | — | — | — | — | 0.02 | 0.99 |

| | | | | |
|---|---|---|---|---|
| powderiness in mouth | 5 | 5 | 3 | 3 |
| sliminess in mouth | 5 | 5 | 5 | 5 |

TABLE 7

| | Comparative | | | | | | | | | |
|---|---|---|---|---|---|---|---|---|---|---|
| | Example 1 | | Example 9 | | Example 10 | | Example 11 | | Example 12 | |
| | | mixing | | mixing | | mixing | | mixing | | mixing |
| | amount | ratio | amount | ratio | amount | ratio | amount | ratio | amount | ratio |
| | (g) | (%) | (g) | (%) | (g) | (%) | (g) | (%) | (g) | (%) |
| dry powder of destroyed | 2 | 100.00 | 2 | 99.75 | 2 | 99.50 | 2 | 99.01 | 2 | 98.52 |
| frond of Wolffia globosa | | | | | | | | | | |
| trisodium citrate | — | — | 0.005 | 0.25 | 0.01 | 0.50 | 0.02 | 0.99 | 0.03 | 1.48 |
| calcium gluconate | — | — | — | — | — | — | — | — | — | — |
| fermented calcium lactate | — | — | — | — | — | — | — | — | — | — |
| sodium chloride | — | — | — | — | — | — | — | — | — | — |

| | | | | | |
|---|---|---|---|---|---|
| powderiness in mouth | 1 | 3 | 3 | 3 | 4 |
| sliminess in mouth | 1 | 3 | 4 | 4 | 5 |

TABLE 8

| | | | | | | | | | Reference | |
|---|---|---|---|---|---|---|---|---|---|---|
| | Example 13 | | Example 14 | | Example 15 | | Example 16 | | Example 1 | |
| | | mixing | | mixing | | mixing | | mixing | | mixing |
| | amount | ratio | amount | ratio | amount | ratio | amount | ratio | amount | ratio |
| | (g) | (%) | (g) | (%) | (g) | (%) | (g) | (%) | (g) | (%) |
| dry powder of destroyed | 2 | 98.04 | 2 | 97.09 | 2 | 99.01 | 2 | 99.01 | 2 | 99.01 |
| frond of Wolffia globosa | | | | | | | | | | |
| trisodium citrate | 0.04 | 1.96 | 0.06 | 2.91 | — | — | — | — | — | — |
| calcium gluconate | — | — | — | — | 0.02 | 0.99 | — | — | — | — |
| fermented calcium lactate | — | — | — | — | — | — | 0.02 | 0.99 | — | — |
| sodium chloride | — | — | — | — | — | — | — | — | 0.02 | 0.99 |

| | | | | | |
|---|---|---|---|---|---|
| powderiness in mouth | 4 | 4 | 2 | 2 | 2 |
| sliminess in mouth | 5 | 5 | 3 | 1 | 1 |

### INDUSTRIAL APPLICABILITY

Drinks or powdered drinks containing destroyed fronds of a Lemnoideae plant and having an improvement in the feeling of sliminess and/or powderiness in the mouth, and a method for improving the feeling of sliminess and/or powderiness in the mouth of drinks or powdered drinks containing destroyed fronds of a Lemnoideae plant can be provided.

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A drink or powdered drink comprising a destroyed frond of a Lemnoideae plant, and an organic acid salt or organic acid.

2. The drink or powdered drink according to claim 1, wherein the organic acid salt is citrate or gluconate.

3. The drink or powdered drink according to claim 1, wherein the organic acid salt is trisodium citrate.

4. A method for improving sliminess and/or powderiness in the mouth, comprising adding an organic acid salt or organic acid to a drink or powdered drink comprising a destroyed frond of a Lemnoideae plant.

5. The method according to claim 4, wherein the organic acid salt is citrate or gluconate.

6. The method according to claim 4, wherein the organic acid salt is trisodium citrate.
